(19) United States
(12) Patent Application Publication
(10) Pub. No.: US 2020/0231244 A1
(43) Pub. Date: Jul. 23, 2020

(54) DETACHABLE BICYCLE HANDLEBAR

(71) Applicant: TIEN HSIN INDUSTRIES CO., LTD., Taichung City (TW)

(72) Inventor: JASON MILES, Taichung City (TW)

(21) Appl. No.: 16/427,464

(22) Filed: May 31, 2019

(30) Foreign Application Priority Data
Jan. 21, 2019 (CN) 201920094046.2

(51) Int. Cl. B62K 21/12; B62K 21/26

(52) U.S. Cl. CPC B62K 21/12; B62K 21/18; B62K 21/26

(57) ABSTRACT

A detachable bicycle handlebar comprises a handlebar body, two grip portions and two fasteners. The handlebar body includes two ends, each end includes a sleeve section and an first hole, and the first hole is formed on an outer peripheral surface of the handlebar body and is communicated with an interior of the sleeve section; the two grip portions are disposed at the two ends of the handlebar body, each grip portion includes a connecting section and a second hole, the second hole is adjacent to one end of the handlebar body and is communicated with an interior of the connecting section, and the connecting section is detachably connected to the sleeve section; and each of the two fasteners passes through the first hole at one end of the handlebar body and is fastened to the second hole of one of the grip portions.

### CROSS-REFERENCE TO RELATED APPLICATION

This application claims the benefit of China Patent Application No. 201920094046.2, filed on Jan. 21, 2019, which is hereby incorporated by reference for all purposes as if fully set forth herein.

### BACKGROUND

### Technical Field

The present disclosure relates to a bicycle handlebar, and particularly, to a detachable bicycle handlebar.

### Related Art

Known bicycle handlebars are shown in FIG. 1 and FIG. 2. Most are integrally formed mainly. After a handlebar is completely manufactured, the inclination and curvature of the bicycle handlebar are fixed, so that the inclination and curvature of the handlebar cannot be adjusted according to the preferences and habits of a rider, and further, the length of the handlebar cannot be adjusted according to the riding situations of the rider and road conditions.

According to a known handlebar (U.S. Pat. No. 594,939) shown in FIG. 3, an outer end of a handle lever A of a bicycle includes a bushing a, a periphery of the bushing a includes external threads for threaded connection to a spherical ferrule b, the spherical ferrule b includes an opening b2, the spherical ferrule b is matched with a base c3, a surface on which the spherical ferrule b is matched with the base c3 is a rough surface or a serrated surface, and a handle c can be made of a metal material or a wood material coated with other materials. A gasket c2 and the base c3 are respectively disposed at two ends of the handle c, an outer surface of the base c3 includes a concave combination seat away from the handle lever A and is used for accommodating the spherical ferrule b, a surface of the combination seat can be roughened or distorted, a main shaft d extends through the spherical ferrule b and the handle c and includes an expanded circular end d1 adjacent to the opening b2 and is jointed to an inner wall of the spherical ferrule b, an outer end d2 of the main shaft d is connected to a locking nut e by means of external threads, a periphery of the main shaft d is wrapped by a tubular rod cl, the locking nut e extends into an first hole c4 of the tubular rod c1, and a head of the locking nut e is pressed against the gasket c2.

Therefore, the handle c can be quickly and easily adjusted relative to the handle lever A, to meet the requirement of the rider.

However, the rider may ride a bicycle in various road conditions. When the rider rides the bicycle on a bumpy road, components, such as the handle lever A, the spherical ferrule b, the handle c, the base c3 and the locking nut e, are loosened due to continuous vibration, and then, a gap is generated between the spherical ferrule b and the base c3, so that the handle c can be arbitrarily rotated or loosened, causing and the riding risk.

### SUMMARY

The technical solution of the present disclosure mainly aims to provide a handlebar characterized in that the inclination and curvature of the handlebar can be adjusted according to the preferences and habits of riders, or handlebars with different shapes can be adjusted and installed according to riding situations and road conditions so as to enable the riding to be more comfortable and safer.

To achieve the aim, the technical solution of the present disclosure discloses a detachable bicycle handlebar, comprising: a handlebar body, comprising two ends; two grip portions, assembled at the two ends of the handlebar body; and two fasteners, wherein each of the two ends of the handlebar body comprises a sleeve section and an first hole, and the first hole is formed on an outer peripheral surface of the handlebar body and is communicated with an interior of the sleeve section; each of the two grip portions comprises a connecting section and a second hole, the second hole is adjacent to one end of the handlebar body and is communicated with an interior of the connecting section, and the connecting section is detachably connected to the sleeve section; and each of the two fasteners passes through the first hole at one end of the handlebar body and is fastened to the second hole of one of the grip portions.

A center line of the first hole and a center line of the sleeve section are collinear.

An inner peripheral surface of the sleeve section and an outer peripheral surface of the connecting section are triangular, rectangular, pentagonal or polygonal.

An inner peripheral surface of the sleeve section and an outer peripheral surface of the connecting section are elliptical.

The radial length of an inner peripheral surface of the sleeve section gradually decreases from the end of the handlebar body to the middle of the handlebar body, and the radial length of an outer peripheral surface of the connecting section gradually increases from one end of the grip portion adjacent to the handlebar body to the direction away from the handlebar body.

The fastener is a bolt.

The detachable bicycle handlebar further comprises at least one cover, the outer peripheral surface of the handlebar body comprises at least one groove, the first hole is formed in the groove, the fastener comprises a head, the head of the fastener is abutted against an inner wall of the groove, the cover is matched with the head of the fastener and the inner wall of the groove by means of configuration of the cover, and the cover is accommodated in the groove.

The groove extends from one end of the handlebar body to the other end of the handlebar body, and the cover is accommodated in the groove by means of configuration of the cover.

The outer peripheral surface of the handlebar body comprises two grooves, the two grooves are respectively adjacent to the two ends of the handlebar body, and two covers are disposed and are respectively accommodated in the two grooves by means of configuration of the two covers.

The fastener comprises an insertion piece, the head of the fastener comprises a first recess, one end of the cover matched with the fastener comprises a second recess, one end of the insertion piece is inserted into the first recess, and the other end of the insertion piece is inserted into the second recess.

The first recess and the second recess may be polygonal, and the insertion piece is matched with the first recess and the second recess by means of configuration of the insertion piece.

The fastener comprises a positioning ring, an outer peripheral surface of the head of the fastener comprises a first ring groove, an inner peripheral surface of an accommodation space of the cover comprises a second ring groove, the second ring groove and the first ring groove are oppositely disposed, and the positioning ring is assembled between the first ring groove and the second ring groove.

The technical solution also discloses a detachable bicycle handlebar, comprising: a handlebar body, comprising two ends, wherein each of the two ends comprises a connecting section, and an first hole is formed in a periphery of each of the two ends and is communicated with an interior of the connecting section; two grip portions, disposed at the two ends of the handlebar body, wherein a sleeve section is extended from each grip portion to the handlebar body, the sleeve section is a tube body and is sleeved over the connecting section, and a second hole is formed in the sleeve section; and two fasteners, wherein each of the two fasteners passes through the first hole at one end of the handlebar body and is fastened to the second hole of one of the grip portions.

The radial length of an outer peripheral surface of the connecting section gradually increases from the end of the handlebar body to the middle of the handlebar body, and the radial length of an inner peripheral surface of the sleeve section gradually decreases from one end of the grip portion adjacent to the handlebar body to the direction away from the handlebar body.

The fastener is a bolt.

An inner peripheral surface of the sleeve section and an outer peripheral surface of the connecting section are non-circular.

Therefore, grip portions with different shapes can be installed according to the preferences and habits of riders or according to different road conditions to adjust the inclination and curvature of the handlebar so as to enable the riding to be more comfortable and safer.

### BRIEF DESCRIPTION OF THE DRAWINGS

FIG. 1 is a schematic diagram of a first integrally formed bicycle handlebar in the related art.

FIG. 2 is a schematic diagram of a second integrally formed bicycle handlebar in the related art.

FIG. 3 is a schematic diagram of a handlebar (U.S. Pat. No. 594,939).

FIG. 4 is a schematic combined diagram of a first embodiment of the present disclosure.

FIG. 5 is a schematic exploded view of the first embodiment of the present disclosure.

FIG. 6 is a cross-sectional view of the first embodiment of the present disclosure.

FIG. 6A is a cross-sectional view taken along a cutting line A-A in FIG. 6.

FIG. 7 is a schematic diagram showing that an inner peripheral surface of a sleeve section and an outer peripheral surface of a connecting section in the present disclosure are triangular.

FIG. 8 is a schematic diagram showing that an inner peripheral surface of a sleeve section and an outer peripheral surface of a connecting section in the present disclosure are elliptical.

FIG. 9 is a schematic diagram showing that an inner peripheral surface of a sleeve section and an outer peripheral surface of a connecting section in the present disclosure are pentagonal.

FIG. 10 is a schematic diagram showing that an inner peripheral surface of a sleeve section and an outer peripheral surface of a connecting section in the present disclosure are hexagonal.

FIG. 11 is a schematic exploded view showing that a handlebar body is assembled with another grip portion according to the first embodiment of the present disclosure.

FIG. 12 is a schematic combined diagram showing that a handlebar body is assembled with another grip portion according to the first embodiment of the present disclosure.

FIG. 13 is a schematic exploded view of a second embodiment of the present disclosure.

FIG. 14 is a cross-sectional view of the second embodiment of the present disclosure.

FIG. 15 is a schematic three-dimensional diagram of a third embodiment of the present disclosure.

FIG. 16 is an exploded three-dimensional view of the third embodiment of the present disclosure.

FIG. 17A is a partially cross-sectional view of the third embodiment of the present disclosure.

FIG. 17B is a partially enlarged view of FIG. 17A.

FIG. 18 is a schematic diagram of a matching tool according to the third embodiment of the present disclosure.

FIG. 19 is a schematic three-dimensional diagram of a fourth embodiment of the present disclosure.

FIG. 20 is an exploded three-dimensional view of the fourth embodiment of the present disclosure.

FIG. 21 is a partially cross-sectional view of the fourth embodiment of the present disclosure.

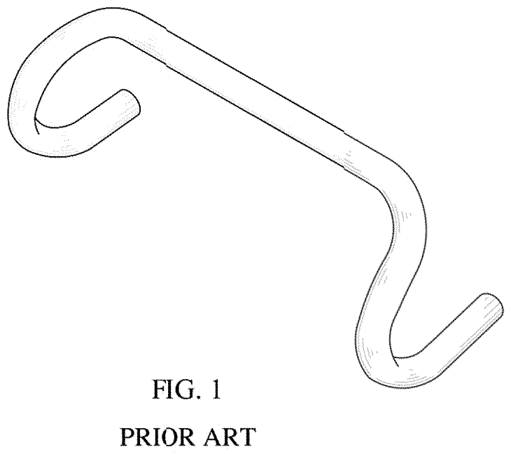

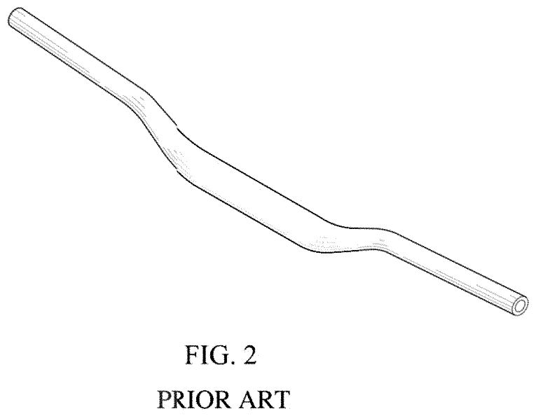

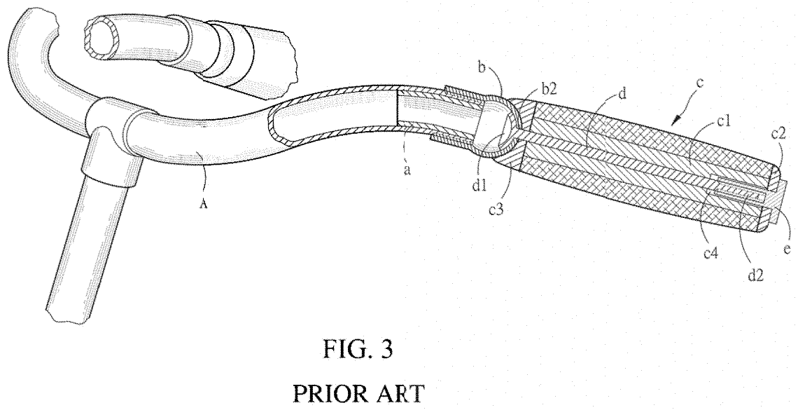

### DETAILED DESCRIPTION

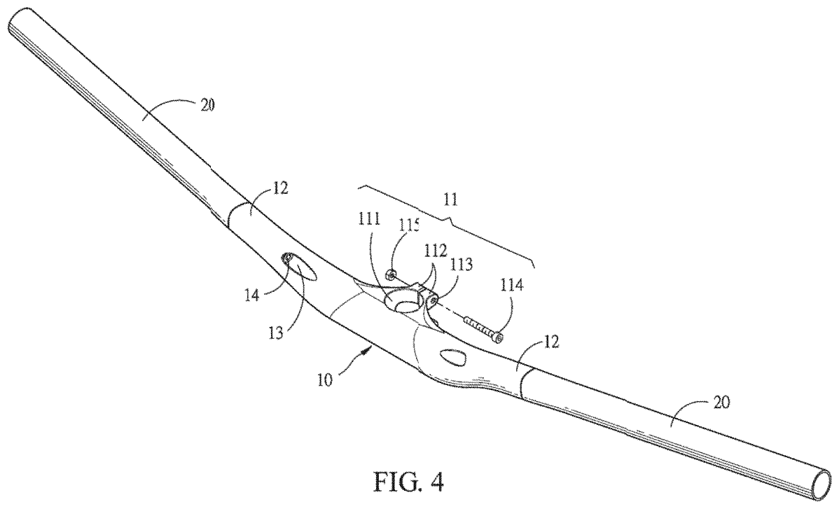

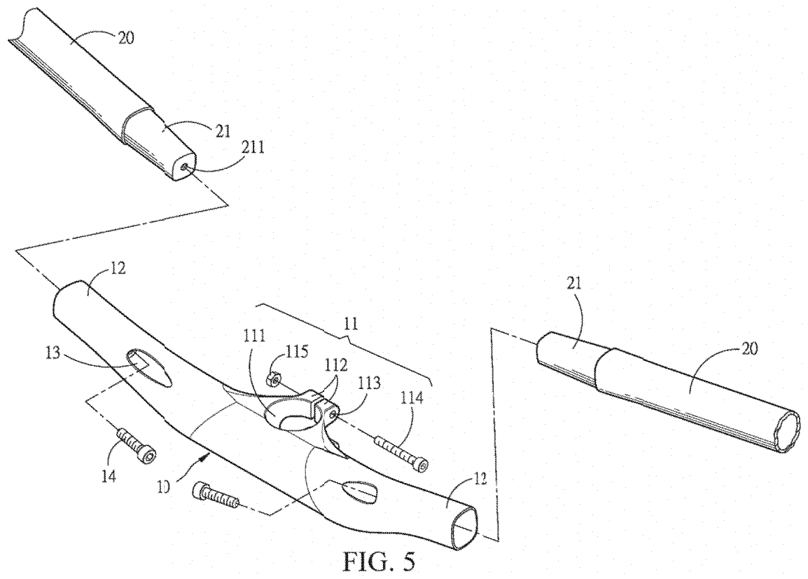

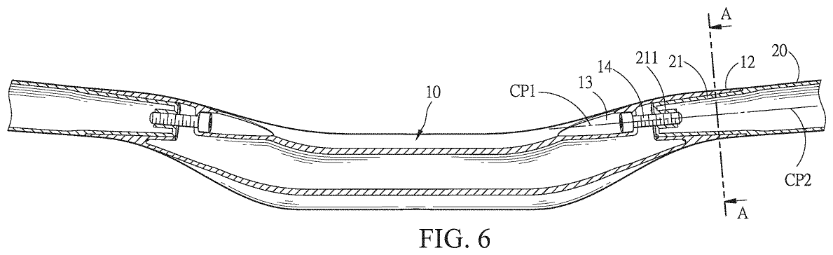

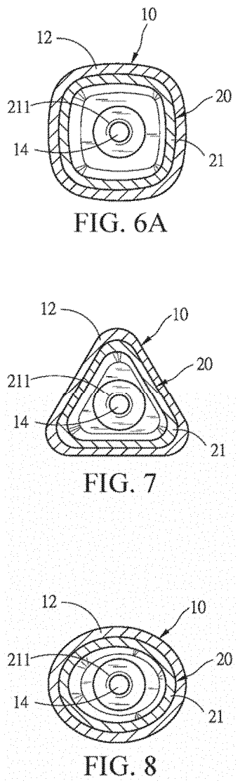

As shown in FIG. 4 to FIG. 6 and FIG. 6A, the present disclosure discloses a detachable bicycle handlebar, including a handlebar body 10 with the middle connected to a steering tube (not shown) of a bicycle and two grip portions 20, where the handlebar body 10 includes two ends, each of the two ends of the handlebar body 10 includes a sleeve section 12 and an first hole 13, and the handlebar body 10 is a hollow tube. A stem assembling portion 11 is extended away from an outer peripheral surface of the handlebar body 10, and is disposed between the two ends of the handlebar body 10. The stem assembling portion 11 includes a sleeve hole 111 and a clamping part 112. The clamping part 112 is formed by extension from the sleeve hole 111 to the direction away from the handlebar body 10, and the clamping part 112 includes at least one connecting hole 113. The connecting hole 113 is used for a connecting piece 114 to pass through to assemble the sleeve hole 111 of the stem assembling portion 11 on the steering tube of the bicycle, so that the handlebar body 10 is fastened to the steering tube and not shakable. In this embodiment, the connecting piece 114 may be a bolt in threaded fit with a nut 115.

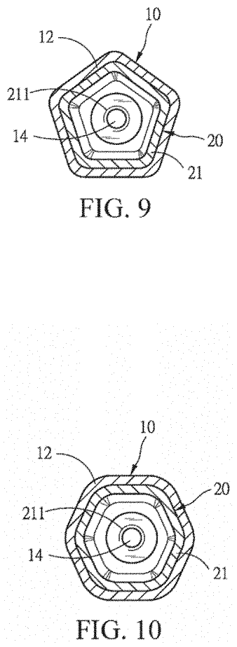

An inner peripheral surface of the sleeve section 12 of the handlebar body 10 is non-circular. In addition, the radial length of the inner peripheral surface of the sleeve section 12 gradually decreases from the end of the handlebar body 10 to the middle of the handlebar body 10. The first hole 13 is formed on an outer peripheral surface of the handlebar body 10 and is communicated with an interior of the sleeve section 12, and the first hole 13 is used for a fastener 14 to pass through. In this embodiment, the fastener 14 may be a bolt. In this embodiment, the inner peripheral surface of the sleeve section 12 is substantially rectangular. In addition, as shown in FIG. 7 to FIG. 10, in other embodiments, the inner peripheral surface of the sleeve section 12 may be a triangle, a pentagon, a hexagon or another polygon, and the inner peripheral surface of the sleeve section 12 may alternatively be an ellipse.

The two grip portions 20 are respectively disposed at the two ends of the handlebar body 10, which are gripped by a rider during riding. Each grip portion 20 is a hollow tube and is extended with a connecting section 21 slipped into the sleeve section 12 and a second hole 211 in the direction towards the handlebar body 10. The outer peripheral surface of the connecting section 21 is matched with the inner peripheral surface of the sleeve section 12. The outer peripheral surface of the connecting section 21 is non-circular, and the radial length of an outer peripheral surface of the connecting section 21 gradually increases from one end of the grip portion 20 adjacent to the handlebar body 10 to the direction away from the handlebar body 10. In this embodiment, the outer peripheral surface of the connecting section 21 is substantially rectangular. In other embodiments, as shown in FIG. 7 to FIG. 10, the outer peripheral surface of the connecting section 21 may be a triangle, a pentagon, a hexagon or another polygon, and the outer peripheral surface of the connecting section 21 may alternatively be an ellipse.

The second hole 211 is formed in one end of the connecting section 21 adjacent to the handlebar body 10, and the second hole 211 is communicated with an interior of the connecting section 21. In this embodiment, the second hole 211 is a screw hole. The second hole 211 is assembled with the fastener 14 to enable the grip portion 20 to be fixed to the handlebar body 10. A center line CP1 of the first hole 13 and a center line CP2 of the sleeve section 12 are collinear.

By means of the above structure, during combination, the connecting section 21 of the grip portion 20 is matched and fixed with the sleeve section 12 of the handlebar body 10, by passing the fastener 14 through the first hole 13 and the second hole 211 of the grip portion 20, so that the grip portion 20 is fixed to the handlebar body 10. Furthermore, by using the combination of the non-circular sleeve section 12 and the non-circular connecting section 21, looseness of the fastener 14 caused by rotation of the grip portion 20 can be avoided when a rider riding a bicycle, so that the riding safety can be ensured.

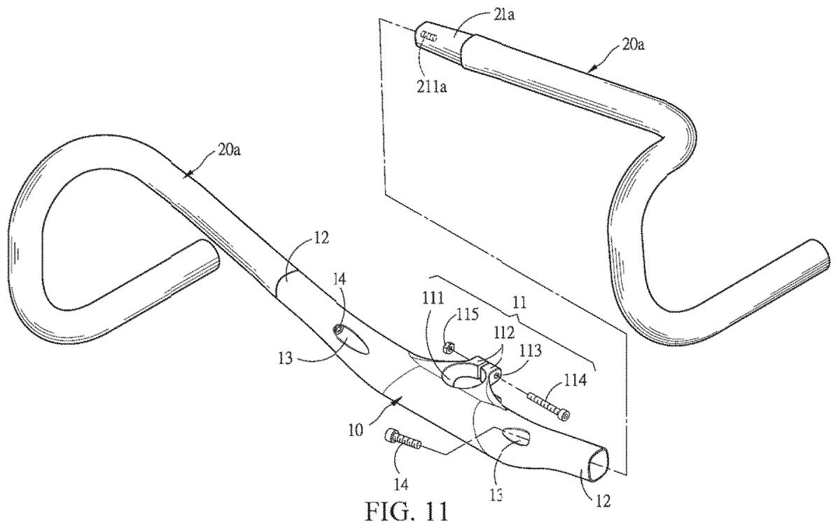

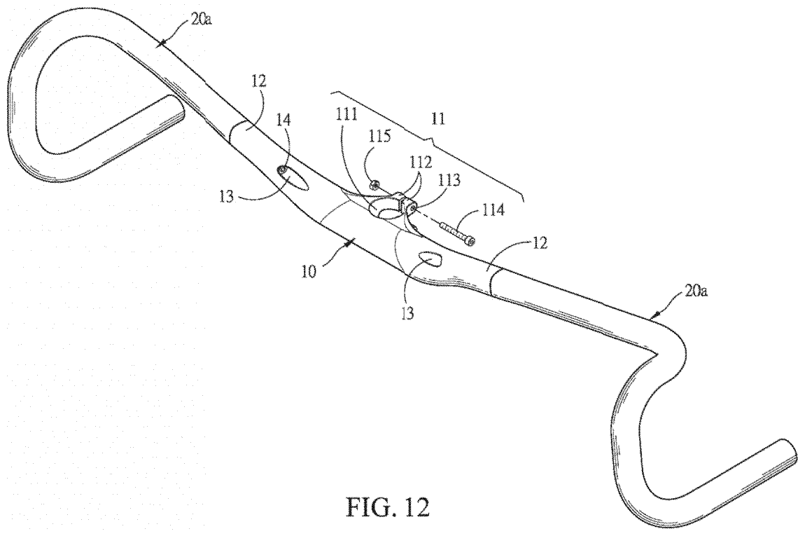

It is worth mentioning that riders can install the grip portions 20 with different shapes or change the inclination and curvature by shifting the angle of the same grip portion, according to the preferences and habits of the riders. When the rider needs to change the shape of the grip portion 20, by loosening the fastener 14, the fastener 14 is separated from the second hole 211 of the grip portion 20, then the grip portion 20 can be detached, and thereby a grip portion 20a with another shape can be mounted on the handlebar body 10 afterwards. As shown in FIG. 11 and FIG. 12, a connecting section 21a of the grip portion 20a is slipped into the sleeve section 12 of the handlebar body 10, by passing the fastener 14 through the first hole 13 of the handlebar body 10 and a second hole 211a of the grip portion 20a, so that grip portions 20a can be assembled on the handlebar body 10.

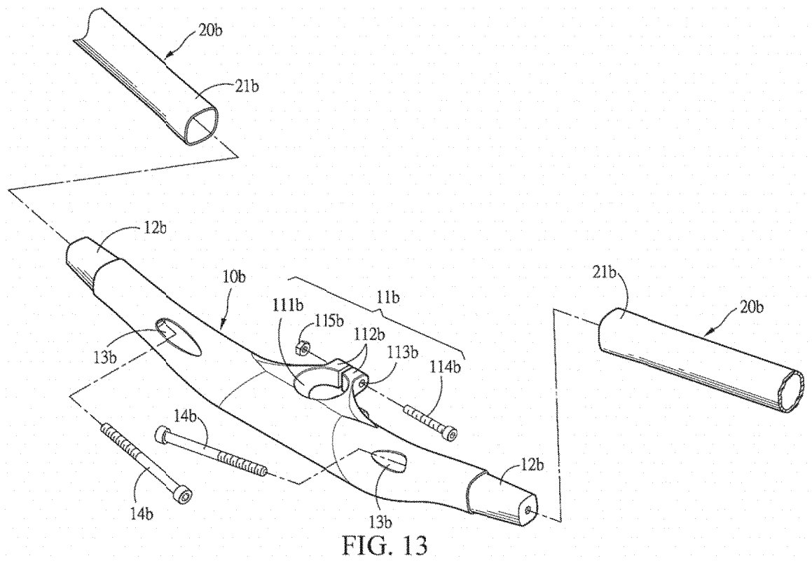

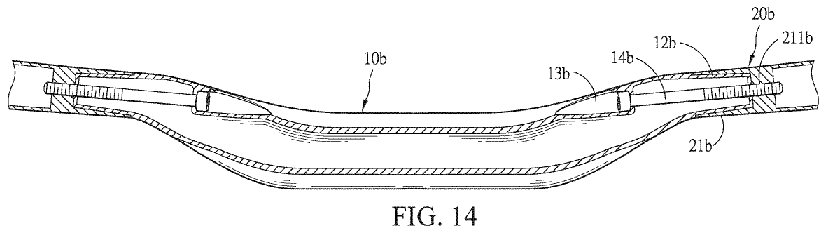

In addition, as shown in FIG. 13 and FIG. 14, a detachable bicycle handlebar according to a second embodiment of the present disclosure, including a handlebar body 10b with the middle connected to a steering tube (not shown) of a bicycle and two grip portions 20b, where the two grip portions 20b are assembled at two ends of the handlebar body 10b, and the handlebar body 10b is a hollow tube. A stem assembling portion 11b is extended away from an outer peripheral surface of the handlebar body 10b, and the stem assembling portion 11b is disposed between the two ends of the handlebar body 10b. The stem assembling portion 11b includes a sleeve hole 111b and a clamping part 112b. The clamping part 112b is formed by extension from the sleeve hole 111b toward the direction away from the handlebar body 10b, and the clamping part 112b includes a connecting hole 113b. The connecting hole 113b is used for a connecting piece 114b to pass through to assemble the sleeve hole 111b of the stem assembling portion 11b in the steering tube of the bicycle, so that the handlebar body 10b is fastened to the steering tube and not shakable. In this embodiment, the connecting piece 114b may be a bolt in threaded fit with a nut 115b.

Each of the two ends of the handlebar body 10b includes a connecting section 12b, an outer peripheral surface of the connecting section 12b is non-circular, and the radial length of the outer peripheral surface of the connecting section 12b gradually increases from the end of the handlebar body 10b to the middle of the handlebar body 10b. In this embodiment, the outer peripheral surface of the connecting section 12b is substantially rectangular, and a first hole 13b is formed in an outer periphery of the handlebar body 10b and the first hole 13b is communicated with an interior of the connecting section 12b.

Each grip portion 20b is a hollow tube and is extended with a sleeve section 21b slipped onto the connecting section 12b towards the handlebar body 10b, an inner peripheral surface of the sleeve section 21b is non-circular, the radial length of the inner peripheral surface of the sleeve section 21b gradually decreases from one end of the grip portion 20b that is adjacent to the handlebar body 10b, toward the direction away from the handlebar body 10b, and the sleeve section 21b includes a second hole 211b. In this embodiment, the inner peripheral surface of the sleeve section 21b is substantially rectangular and may alternatively be a non-circular shape, such as a triangle or a pentagon, shown in FIG. 7 to FIG. 10, and the second hole 211b is a screw hole.

The fastener 14b passes through the first hole 13b and is combined with the second hole 211b of the handlebar body 20b. In this embodiment, the fastener 14b is a bolt.

According to the second embodiment of the present disclosure, only by loosening the fastener 14b, the grip portion 20b is detached, then turning the grip portion 20b to another angle or replacing the grip portion 20b with other grip portion in a different shape (not shown), and thereafter the grip portion 20b is reinstalled to the handlebar body 10b. Therefore, grip portions with different shapes or different angle can be installed according to the preferences and habits of the rider or according to different road conditions to adjust the inclination and curvature of the handlebar so as to enable a more comfortable and safer riding.

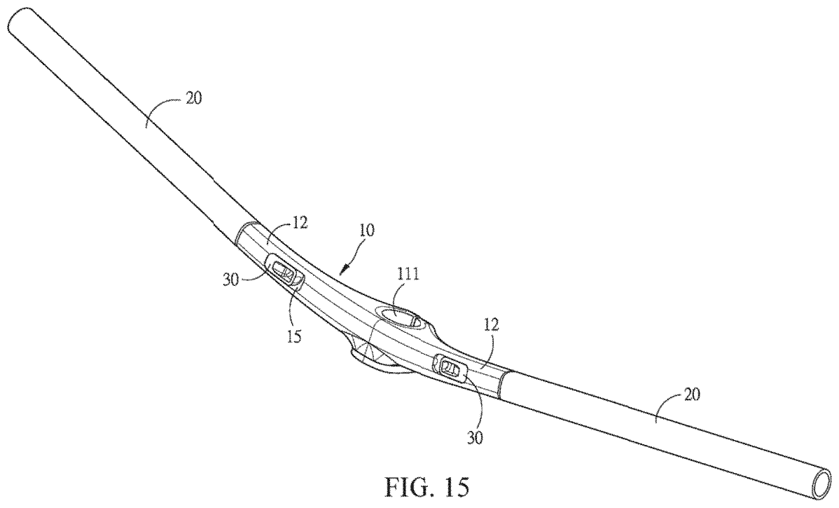

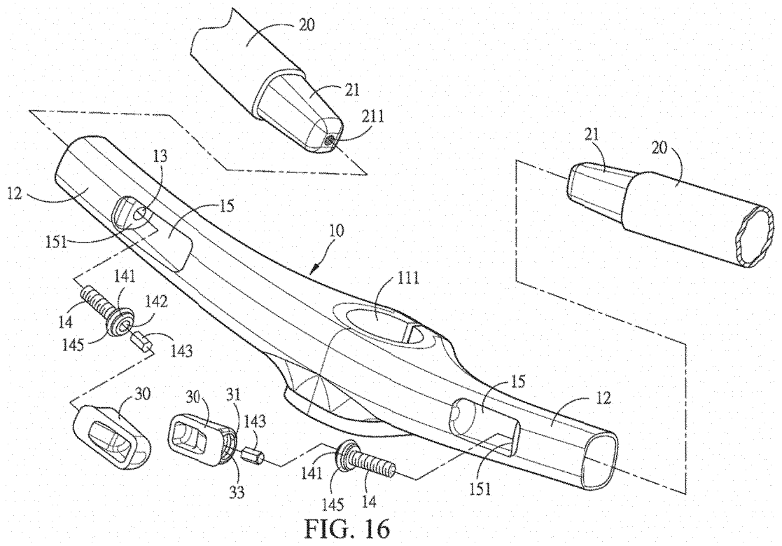

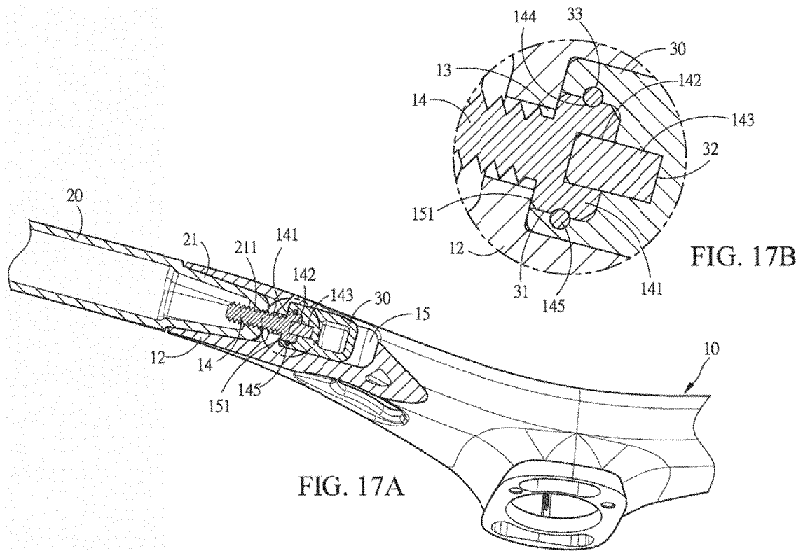

As shown in FIG. 15, FIG. 16, FIG. 17A and FIG. 17B, a detachable bicycle handlebar according to a third embodiment of the present disclosure is substantially the same as the detachable bicycle handlebar according to the first embodiment, and includes a handlebar body 10 with the middle connected to a steering tube (not shown) of a bicycle and two grip portions 20, where the handlebar body 10 includes two ends, each of the two ends of the handlebar body 10 includes a sleeve section 12 and an first hole 13, and the handlebar body 10 is a hollow tube. An inner peripheral surface of the sleeve section 12 of the handlebar body 10 is non-circular. The radial length of the inner peripheral surface of the sleeve section 12 gradually decreases from the end of the handlebar body 10 to the middle of the handlebar body 10. The first hole 13 is formed on an outer peripheral surface of the handlebar body 10 and is communicated with an interior of the sleeve section 12, and the first hole 13 allows a fastener 14to pass therethrough.

One of the two grip portions 20 are disposed at one of the two ends of the handlebar body 10 respectively. Each grip portion 20 is extended with a connecting section 21 slipped into the sleeve section 12 and a second hole 211 extended towards the direction of the handlebar body 10. The outer peripheral surface of the connecting section 21 is matched with the inner peripheral surface of the sleeve section 12, an outer peripheral surface of the connecting section 21 is non-circular, the radial length of the outer peripheral surface of the connecting section 21 gradually increases from one end of the grip portion 20 adjacent to the handlebar body 10 to the direction away from the handlebar body 10. The fastener 14 passes through the first hole 13 and is combined with the second hole 211 of the handlebar body 20. Therefore, one of the two grip portions 20 is fixed to one of the two ends of the handlebar body 10.

The differences are as follows: An outer peripheral surface of the handlebar body 10 includes two grooves 15 and two covers 30, and each of the two covers 30 is respectively accommodated in one of the two grooves 15, where each of the two grooves 15 is adjacent to one of the two ends of the handlebar body 10. The first hole 13 is formed in the groove 15. One end of the fastener 14 includes a head 141. When the fastener 14 passes through the first hole 13, the head 141 is abutted against an inner wall 151 of the groove 15 and engaged with the cover 30 by a matching configuration, and therefore the cover 30 is accommodated in the groove 15. In this embodiment, the cover 30 includes an accommodation space 31 in a direction towards the fastener 14, the configuration of the accommodation space 31 is matching with the head 141 of the fastener 14, and a second recess 32 is formed in the accommodation space 31.

In this embodiment, the fastener 14 further includes an insertion piece 143 disposed between the fastener 14 and the cover 30. The head 141 of the fastener 14 includes a first recess 142, and the first recess 142 can be polygonal. One end of the insertion piece 143 is inserted into the first recess 142 of the fastener 14, and the other end of the insertion piece 143 is inserted into a second recess 32 in the accommodation space 31. The second recess 32 can be polygonal, and two ends of the insertion piece 143 can also be polygons that match with the first recess 142 and the second recess 32. The insertion piece 143 can increase the contact area and friction between the fastener 14 and the accommodation space 31 so as to reduce the risk of loosening the two grip portions 20 from the handlebar body 10 due to wear of the fastener 14.

In this embodiment, the fastener 14 can further include a first ring groove 144 and a positioning ring 145 disposed on an outer peripheral surface of the head 141, and the cover 30 can further include a second ring groove 33 disposed on an inner peripheral surface of the accommodation space 31. The first ring groove 144 and the second ring groove 33 are oppositely disposed. The positioning ring 145 is clamped between the first ring groove 144 and the second ring groove 33, so that the positioning ring 145 can be accommodated between the fastener 14 and the cover 30. The positioning ring 145 can increase the contact area and friction between the fastener 14 and cover 30 so as to reduce the risk that the two grip portions 20 loosening from the handlebar body 10 due to wear and tear of the fastener 14.

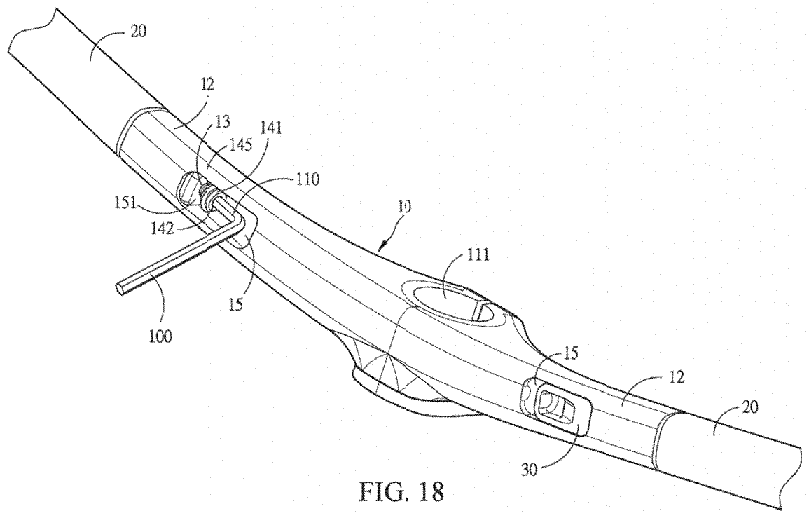

As shown in FIG. 18, the first recess 142 can be sleeved with an actuating part 110 of a tool 100 to rotate and fix the fastener 14. After the fastener 14 passes through the first hole 13 and is screwed in the second hole 211, the cover 30 is mounted in the groove 15, and the cover 30 is matched with a head 141 of the fastener 14 and an inner wall 151 of the groove 15 by a matching configuration of the cover 30 so as to increase the contact area and friction of the first hole 13. Especially, the fastener 14 connects to the cover 30 through the insertion piece 143 so as to strengthen the bonding force between the cover 30 and the fastener 14, and a positioning ring 145 is assembled between the first ring groove 144 of the fastener 14 and the second ring groove 33 of the cover 30 so as to strengthen the fastening force between the cover 30 and the fastener 14, further increasing the stress strength of the first hole 13 of the handlebar body 10 and the second hole 211 of the grip portion 20. The cover 30, can not only keep the integrality of the appearance of the handlebar body 10, but also can reduce a wind drag.

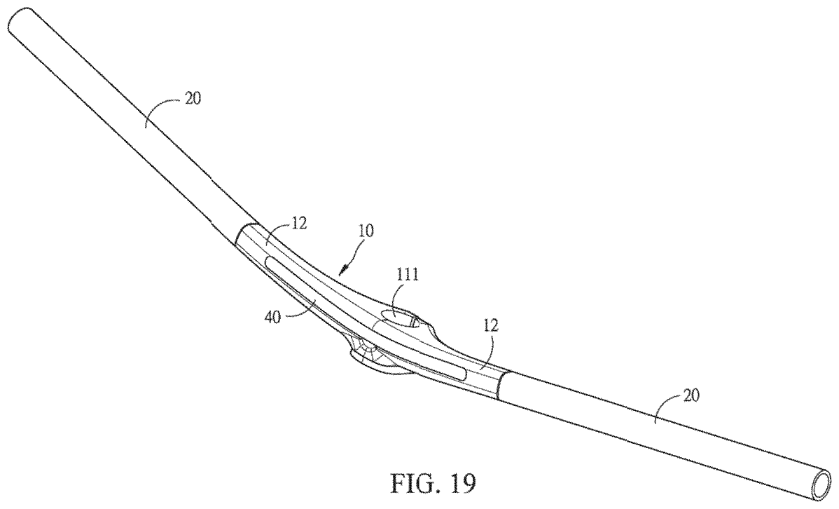

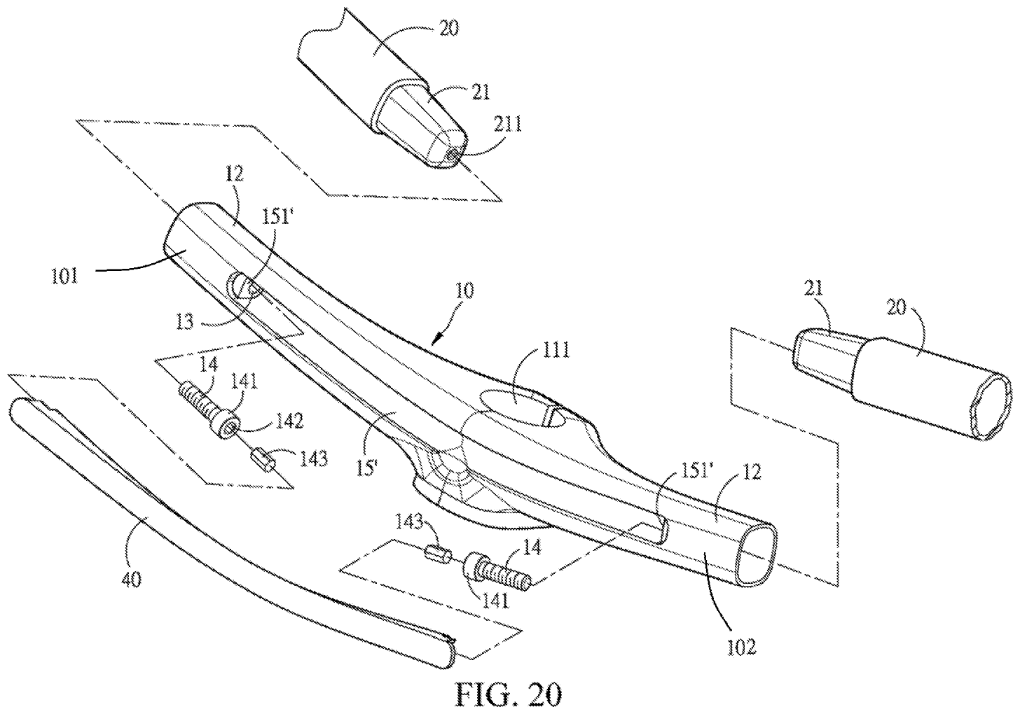

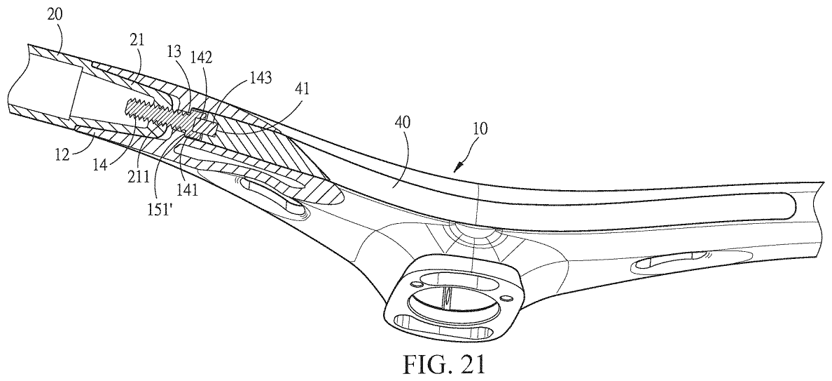

As shown in FIG. 19 to FIG. 21, a detachable bicycle handlebar according to a fourth embodiment of the present disclosure is substantially the same as the detachable bicycle handlebar according to the first embodiment. The fourth embodiment includes a handlebar body 10 with the middle connected to a steering tube (not shown) of a bicycle and two grip portions 20, where the handlebar body 10 includes two ends, each of the two ends of the handlebar body 10 includes a sleeve section 12 and an first hole 13, and the handlebar body 10 is a hollow tube. An inner peripheral surface of the sleeve section 12 of the handlebar body 10 is non-circular. The radial length of the inner peripheral surface of the sleeve section 12 gradually decreases from the end of the handlebar body 10 to the middle of the handlebar body 10. The first hole 13 is formed at an outer peripheral surface of the handlebar body 10 and is communicated with an interior of the sleeve section 12, and the first hole 13 allows a fastener 14 to pass therethrough.

The two grip portions 20 are respectively disposed at the two ends of the handlebar body 10. Each grip portion 20 is extended with a connecting section 21 which slipped into the sleeve section 12 and a second hole 211 in the direction toward the handlebar body 10. An outer peripheral surface of the connecting section 21 is matched with the inner peripheral surface of the sleeve section 12, the outer peripheral surface of the connecting section 21 is non-circular, the radial length of the outer peripheral surface of the connecting section 21 gradually increases from one end of the grip portion 20 adjacent to the handlebar body 10 to the direction away from the handlebar body 10. The fastener 14 passes through the first hole 13 and is combined with the second hole 211 of the handlebar body 20.

The differences are as follows: An outer peripheral surface of the handlebar body 10 includes a groove 15′ and a cover 40 is accommodated in the groove 15′, and the groove 15′ extends from one end of the handlebar body 10 to the other end of the handlebar body 10. The first hole 13 is formed in the groove 15′ and is adjacent to one end of the handlebar body 10. One end of the fastener 14 includes a head 141. When the fastener 14 passes through the first hole 13, the head 141 is abutted against an inner wall 151′ of the groove 15′, the cover 40 is assembled with the inner wall 151′ of the groove and the head 141 of the fastener 14 by a matching configuration of the cover 40, and the cover 40 is accommodated in the groove 15′.

In this embodiment, the fastener 14 further includes an insertion piece 143 disposed between the fastener 14 and the cover 40, the head 141 of the fastener 14 includes a first recess 142, the first recess 142 can be polygonal, the cover 40 includes a second recess 41 matched with the configuration of the insertion piece 143 towards the direction of the first hole 13, and the second recess 41 can be polygonal. During mounting, one end of the insertion piece 143 is inserted into the first recess 142 of the fastener 14, the other end of the insertion piece 143 is inserted into the second recess 41 of the cover 40 by matching configuration. Both the two ends of the insertion piece 143 can be polygons and respectively matched with the first recess 142 and the second recess 41. The insertion piece 143 can increase the contact area and friction between the fastener 14 and the cover 40 so as to reduce the risk that the two grip portions 20 are loosened from the handlebar body 10 due to abrasion of the fastener 14, and can keep the integrality of the appearance of the handlebar body 10 and can reduce a wind drag.

What is claimed is:

1. A detachable bicycle handlebar, comprising:
a handlebar body, comprising two ends, wherein each of the two ends of the handlebar body comprises a sleeve section and a first hole, and the first hole is formed in an outer peripheral surface of the sleeve section of the handlebar body and is communicated with an interior of the sleeve section;
two grip portions, disposed at the two ends of the handlebar body, wherein each of the two grip portions comprises a connecting section, the second hole is adjacent to one end of the handlebar body, the second hole is formed in the connecting section, the second hole is communicated with an interior of the connecting section, and the connecting section is detachably connected to the sleeve section; and
two fasteners, wherein one of the two fasteners passes through a corresponding one of the two first holes and is fastened to a corresponding one of the two second holes, and another corresponding one of the two fasteners passes through another corresponding one of the two first holes and is fastened to another corresponding one of the two second holes;
wherein an inner peripheral surface of the sleeve section decreases in a radial length in an axial direction from a corresponding one of the two ends of the handlebar body to the middle of the handlebar body, and an outer peripheral surface of the corresponding connecting section increases in an axial direction from a corresponding one of the two ends of the corresponding grip portion adjacent to the handlebar body to another corresponding one of the two ends of the grip portion away from the handlebar body.

2. The detachable bicycle handlebar according to claim 1, wherein a center line of the first hole and a center line of the sleeve section are collinear.

3. The detachable bicycle handlebar according to claim 1, wherein an inner peripheral surface of the sleeve section and an outer peripheral surface of the connecting section are polygonal.

4. The detachable bicycle handlebar according to claim 1, wherein an inner peripheral surface of the sleeve section and an outer peripheral surface of the connecting section are triangular, rectangular or pentagonal.

5. The detachable bicycle handlebar according to claim 1, wherein an inner peripheral surface of the sleeve section and an outer peripheral surface of the connecting section are elliptical.

6. (canceled)

7. The detachable bicycle handlebar according to claim 1, wherein each of the fasteners is a bolt.

8. The detachable bicycle handlebar according to claim 1, further including at least two covers, wherein an outer peripheral surface of the handlebar body comprises at least two grooves, the first hole is formed in a corresponding one of the grooves, the corresponding fastener comprises a head, the head of the corresponding fastener is abutted against an inner wall of the corresponding one of the grooves, a corresponding one of the covers is disposed with the head of the corresponding fastener and the inner wall of the corresponding one of the grooves by a matching configuration of the corresponding one of the covers, and the corresponding one of the covers is accommodated in the corresponding one of the grooves.

9. The detachable bicycle handlebar according to claim 8, wherein the groove extends from one of the two ends to the other one of the two ends of the handlebar body, and the cover is accommodated in the groove by the matching configuration of the cover.

10. The detachable bicycle handlebar according to claim 8, wherein the outer peripheral surface of the handlebar body comprises two grooves, the two grooves are respectively adjacent to the each of the two ends of the handlebar body, and the two covers are disposed and respectively accommodated in the two grooves by matching configuration of the two covers.

11. The detachable bicycle handlebar according to claim 8, wherein the fastener comprises an insertion piece, the head of the fastener comprises a first recess, a corresponding one of two ends of the cover matched with the fastener comprises a second recess, a corresponding one of two ends of the insertion piece is disposed at the first recess, and another corresponding one of two ends of the insertion piece is disposed at the second recess.

12. The detachable bicycle handlebar according to claim 11, wherein the first recess and the second recess can be polygonal, and the insertion piece is matched with the first recess and the second recess by matching configuration of the insertion piece.

13. The detachable bicycle handlebar according to claim 8, wherein the fastener comprises a positioning ring, an outer peripheral surface of the head of the fastener comprises a first ring groove, the cover comprises an accommodation space for accommodating the head of the fastener, the accommodation space comprises a second ring groove, the second ring groove and the first ring groove are oppositely disposed, and the positioning ring is assembled between the first ring groove and the second ring groove.

14. A detachable bicycle handlebar, comprising:
a handlebar body, comprising two ends, wherein each of the two ends comprises a connecting section, and a first hole is formed in a periphery of each of the two ends and is communicated with an interior of the connecting section;
two grip portions, disposed at the two ends of the handlebar body, wherein a sleeve section is extended in a direction from each grip portion to the handlebar body, the sleeve section is a tube body and is slipped onto the connecting section, and a second hole is formed in the sleeve section; and
two fasteners, wherein one of the two fasteners passes through a corresponding one of the two first holes and is fastened to a corresponding one of the two second holes, and another corresponding one of the two fasteners passes through another corresponding one of the two first holes and is fastened to another corresponding one of the two second holes;
wherein an outer peripheral surface of the corresponding connecting section increases in a radial length in an axial direction from a corresponding one of the two ends of the handlebar body to the middle of the handlebar body, and an inner peripheral surface of the sleeve section decreases in a radial length in an axial direction from a corresponding one of the two ends of the corresponding grip portion adjacent to the handlebar body to another corresponding one of the two ends of the grip portion from the handlebar body.

15. (canceled)

16. The detachable bicycle handlebar according to claim 14, wherein each of the fasteners is a bolt.

17. The detachable bicycle handlebar according to claim 14, wherein an inner peripheral surface of the sleeve section and an outer peripheral surface of the connecting section are non-circular.
